(19) United States
(12) Patent Application Publication
(10) Pub. No.: US 2020/0248672 A1
(43) Pub. Date: Aug. 6, 2020

(54) HUB FOR A WIND TURBINE, WIND TURBINE AND METHOD FOR UP-GRADING A HUB OF A WIND TURBINE

(71) Applicant: Siemens Gamesa Renewable Energy A/S, Brande (DK)

(72) Inventors: Nicolas Chernobilsky, Vejle (DK); Christian Laursen, Hedensted (DK)

(21) Appl. No.: 16/776,575

(22) Filed: Jan. 30, 2020

(30) Foreign Application Priority Data
Jan. 31, 2019 (EP) 19154791.8

(51) Int. Cl. F03D 1/06; F03D 80/70

(52) U.S. Cl. CPC F03D 1/0691; F03D 80/70; F05B 2240/21; F05D 2300/111; F05D 2240/50

(57) ABSTRACT

A hub for a wind turbine which includes a hub body having a first blade bearing flange, a second blade bearing flange and a main bearing flange, and a stiffening structure stiffening a first portion of the hub body, wherein the first portion is arranged adjacent to the main bearing flange and between the first blade bearing flange and the second blade bearing flange. This hub has the advantage that a stiffness (or a rigidity) of the hub body can be increased close to the main bearing flange.

### CROSS-REFERENCE TO RELATED APPLICATIONS

This application claims priority to European Patent Application No. EP 19154791.8, having a filing date of Jan. 31, 2019, the entire contents of which are hereby incorporated by reference.

### FIELD OF TECHNOLOGY

The following relates to a hub for a wind turbine, a wind turbine with such a hub and a method for upgrading a hub of a wind turbine.

### BACKGROUND

For increasing the power output and the efficiency of wind turbines, sizes of rotors are increased. This requires that the dimensions of a hub of the rotor and/or the main bearing is increased in order to provide sufficient stability and longevity of the wind turbine.

However, as the size of the rotor increases the mechanical stress during operation of the wind turbine is also increased. This can lead to dynamic deformations of a hub body and might induce compression variations around a circumference of the main bearing. This can reduce the service life of the main bearing, leading to high servicing costs and unplanned production downtimes.

### SUMMARY

An aspect relates to providing an improved hub for a wind turbine.

According to a first aspect, a hub for a wind turbine is provided. The hub comprises a hub body having a first blade bearing flange, a second blade bearing flange and a main bearing flange. Further, a stiffening structure stiffening a first portion of the hub body is provided, wherein the first portion is arranged adjacent to the main bearing flange and between the first blade bearing flange and the second blade bearing flange.

This hub has the advantage that a stiffness (or a rigidity) of the hub body can be increased close to the main bearing flange. For example, a stress on a specific position in a main bearing mounted to the main bearing flange can vary due to static and/or dynamic loads. By increasing the stiffness of the hub body, the stress is distributed more evenly and the variation of the load can be reduced significantly. Thus, a service life of a main bearing mounted to the main bearing flange can be increased significantly, leading to longer operation times, reduced servicing costs and increased efficiency of the wind turbine.

Further, a material thickness of the hub body can be reduced without loss of stiffness, which allows to reduce the material needed for the hub body, reducing the cost. Alternatively, the stiffness may be increased without increasing the material thickness of the hub body, allowing higher loads.

The stiffness or rigidity of the hub body as used herein denotes a resistance of the hub body against deformations due to mechanical stress or strain or a load applied during use of the hub in a wind turbine. Higher stiffness leads to smaller deformations at a given stress, which is desirable.

For example, the hub body has a large main bearing flange configured for mounting the main bearing. Further, the hub body has at least two blade bearing flanges for mounting blade bearings which allow to adjust a blade angle with respect to the wind (pitch). A rotational symmetry axis of the blade bearing flanges are, for example, arranged essentially orthogonal to a rotational symmetry axis of the main bearing flange. This does not exclude small deviations, up to 20°, from an orthogonal arrangement. Thus, blades mounted to the hub are pointing in an essentially outward radial direction with respect to the rotational symmetry axis of the main bearing flange.

In an exemplary embodiment, the stiffness of the hub body is equal at any two positions around the circumference of the main bearing flange in order to reduce load variations in the main bearing during operation.

According to an embodiment, the stiffening structure comprises a rib formed integrally with the hub body.

A rib is a relatively simple way of increasing the stiffness of a structure, such as the hub body. The rib is formed during manufacture of the hub body, for example during casting or machining of the hub body. Forming the rib integrally with the hub body ensures a direct force transmission.

According to a further embodiment, the hub body comprises a second portion, the second portion being arranged adjacent to the main bearing flange and between the first blade bearing flange and the second blade bearing flange, wherein at least the first blade bearing flange or the second blade bearing flange is arranged between the first portion and the second portion, wherein the stiffening structure connects the first portion and the second portion.

For example, a hub body having two blade bearing flanges arranged on opposite sides of the hub body across the main bearing flange has two portions with a relatively low stiffness, which are arranged between the two blade bearing flanges and are facing each other across the main bearing flange, the first portion and the second portion. In this embodiment, the stiffening structure connects the first portion and the second portion, such that a force acting on the first portion is transferred via the stiffening structure to the second portion and vice versa. Thus, the first portion and the second portion support each other, increasing their stiffness.

According to a further embodiment, the stiffening structure spans from the first portion to the second portion such that an opening is formed between the stiffening structure and the hub body.

This embodiment has the advantage that access to the main bearing flange through the opening is possible even with the stiffening structure installed in or mounted to the hub body, which simplifies use of the hub.

For example, the stiffening structure comprises a strut, a spoke and/or a similar structure that is configured for transferring both compressive and tensile forces. In further embodiments, the stiffening structure comprises a mesh or lattice structure. A geometry of the stiffening structure is optimized as a function of a direction of the forces or local stresses and strains that are expected to occur during operation of the wind turbine and that are to be transferred by the stiffening structure. For this, mechanical simulation tools, such as finite element simulations, may be employed.

The stiffening structure may be made from material comprising steel, aluminum, casted iron, composite material, and/or fiber material, in particular carbon fiber. Further, the stiffening structure may comprise a porous material and may have an internal structure such as bone or wood.

According to a further embodiment, the hub body comprises a third blade bearing flange and a third portion, the third portion being arranged adjacent to the main bearing flange and between the first blade bearing flange and the third blade bearing flange. At least one of the first, second or third blade bearing flanges is arranged between the first portion and the third portion and at least one other of the first, second or third blade bearing flanges is arranged between the second portion and the third portion. The stiffening structure has a Y-shape connected to the hub at the first, second and third portion.

In particular, a first end of the Y-shaped stiffening structure is connected to the first portion, a second end of the Y-shaped stiffening structure is connected to the second portion and a third end of the Y-shaped stiffening structure is connected to the third portion. The Y-shape has point symmetry. It is to be understood that the term Y-shape is not limiting the form of the stiffening structure to star shape having three spikes. Rather, forms having a shape of a plus-sign or shapes which have four or more spikes are also encompassed by this terminology. Further, the connecting legs may have a curved shape and do not necessarily follow a straight line.

Specifically, a Y-shape is suitable in embodiments where the hub body has three blade bearing flanges and is configured for being employed in a wind turbine having three blades.

It becomes evident that the number of portions such as the first, second or third portion as described is equal to the number of implemented blade bearing flanges. The blade bearing flanges are arranged on the hub body in a regular manner, such that their centers define a circle that has a center arranged on the rotational symmetry axis of the main bearing flange and an angle between the centers of two neighboring blade bearing flanges is given by 360° divided by the number of blade bearing flanges. Then, one such portion is arranged between each two neighboring blade bearing flanges, close to the main bearing flange.

According to a further embodiment, the stiffening structure is arranged inside the hub body.

The hub body, which may also be referred to as a housing, may house many further elements of the wind turbine not mentioned herein.

According to a further embodiment, the stiffening structure comprises at least two reinforcing elements joined to each other.

This embodiment allows to use a number of smaller reinforcing elements, which can be less complex and which can be manufactured, handled and installed easier than one large stiffening structure, such as a Y-shaped plate. By joining the reinforcing elements to each other, a rigidity of the stiffening structure is increased.

The reinforcing elements may be made from material comprising steel, composite material, and/or fiber material, in particular carbon fiber. Further, the reinforcing elements may comprise a porous material and may have an internal structure such as bone or wood.

The reinforcing elements are bolted to the hub body in the first, second and/or third portion of the hub body.

The two reinforcing elements may be joined to each other by using an additional plate bolted (or joined in a different manner, such as welding or gluing) to each of the reinforcing elements. Further, the reinforcing elements may be joined by welding, soldering, and/or gluing. Also, clips and/or brackets may be used for joining.

According to a further embodiment, the stiffening structure comprises at least one man hole.

This embodiment has the advantage that service operations on the main bearing flange can be performed without the need to remove or dismount the stiffening structure.

For example, in embodiments where the stiffening structure has a Y-shape, the man hole may be arranged centrally on a symmetry axis of the main bearing flange. The Y-shape is designed such that it has point symmetry, and the man hole is arranged on the symmetry axis of the Y-shape.

In embodiments, the hub body has three blade bearing flanges and the stiffening structure comprises three identical reinforcing elements having a curved shape, for example an essentially circular arc of 90° to 120°. A first reinforcing element spans from the first portion to the second portion. A second reinforcing element spans from the second portion to the third portion. And a third reinforcing element spans from the third portion to the first portion. Further, the first reinforcing element is joined to the second reinforcing element at a common position close to the second portion. The second reinforcing element is joined to the third reinforcing element at a common position close to the third portion. And the third reinforcing element is joined to the first reinforcing element at a common position close to the first portion. The three reinforcing elements arranged as described may resemble a Y-shape.

According to a further embodiment, the main bearing flange has a diameter of at least two meters.

The larger the diameter of the main bearing flange, the more important it is to equalize of the stiffness of the hub body around the circumference of the main bearing flange.

According to a further embodiment, the hub body is made from cast iron.

According to a second aspect, a wind turbine comprising a hub according to the first aspect is suggested.

This wind turbine has the advantage that a service life of the main bearing of the hub may be increased.

According to an embodiment, the wind turbine is implemented as a direct drive wind turbine.

Direct drive wind turbines can benefit from the increased stiffness provided by the hub in particular, because a massive shaft that provides high stiffness may be omitted.

According to a third aspect, a method for upgrading a hub of a wind turbine is suggested, wherein a stiffening structure is joined to a hub body of the hub for stiffening a first portion of the hub body. The hub body comprises a first blade bearing flange, a second blade bearing flange and a main bearing flange. The first portion is arranged adjacent to the main bearing flange and between the first blade bearing flange and the second blade bearing flange.

This method has the advantage that existing wind turbines and/or hubs that are already produced may be equipped or fitted with the stiffening structure, such that the benefits described in accordance with the first aspect may be obtained. Of course, all embodiments described in accordance with the first aspect apply mutatis mutandis to the third aspect.

Any embodiment of the first aspect may be combined with any embodiment of the first aspect to obtain another embodiment of the first aspect.

Further possible implementations or alternative solutions of the embodiment also encompass combinations—that are not explicitly mentioned herein—of features described above or below with regard to the embodiments. The person skilled in the art may also add individual or isolated aspects and features to the most basic form of the embodiment.

### BRIEF DESCRIPTION

Some of the embodiments will be described in detail, with reference to the following figures, wherein like designations denote like members, wherein:

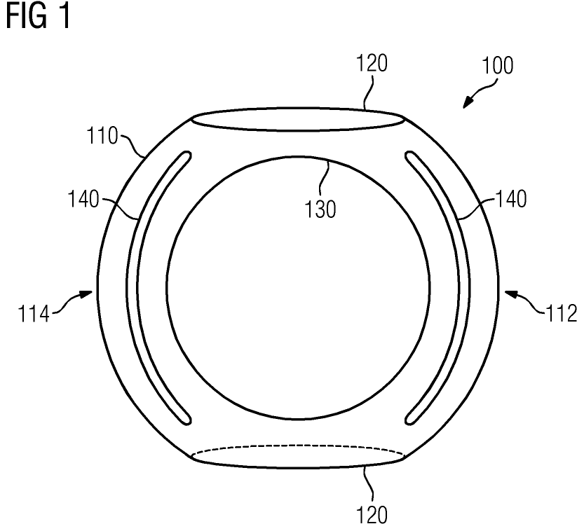

FIG. 1 depicts a schematic view of a first example of a hub;

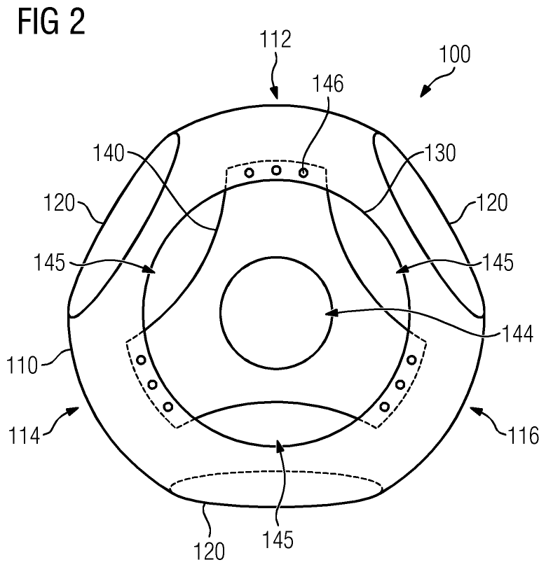

FIG. 2 depicts a schematic view of a second example of a hub;

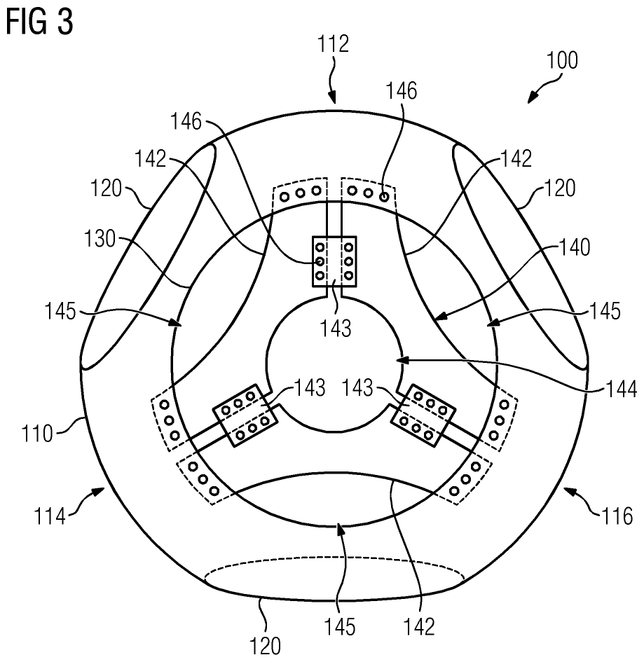

FIG. 3 depicts a schematic view of a third example of a hub; and

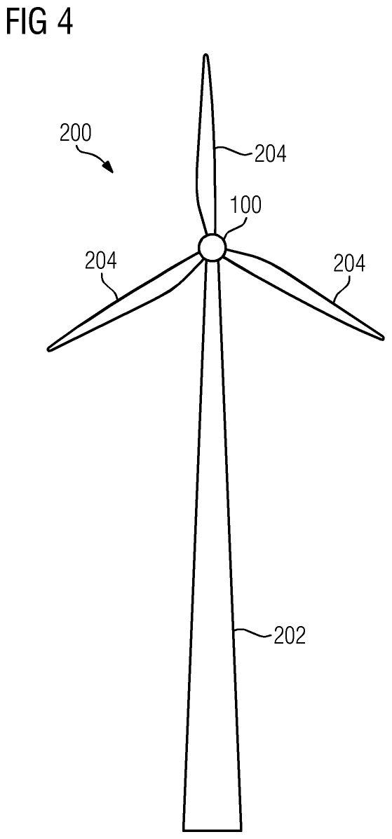

FIG. 4 depicts a schematic view of an example of a wind turbine.

In the Figures, like reference numerals designate like or functionally equivalent elements, unless otherwise indicated.

### DETAILED DESCRIPTION

FIG. 1 shows a schematic view of a first example of a hub 100 for a wind turbine 200 (see FIG. 4). In this first example, the hub 100 has a hub body 110 with a first blade bearing flange 120, a second blade bearing flange 120 and one main bearing flange 130. Thus, this hub 100 is configured for carrying two blades 204 (see FIG. 4).

For example, the main bearing flange 130 has a diameter of 4.5 m and the first and second blade bearing flanges 120 each have a diameter of 4 m. For example, the hub body 110 is made from cast iron. In order to provide a sufficient stiffness or rigidity of the hub 100, particularly close to the main bearing flange 130, without massively increasing a material thickness of the hub body 110, two stiffening structures 140 are provided. In this example, the stiffening structures 140 are implemented integrally as a rib in the hub body 110. The ribs 140 are arranged at positions of the hub body 110 in a first portion 112 and in a second portion 114. Both the first portion 112 and the second portion 114 are arranged adjacent to the main bearing flange 130 and between the first blade bearing flange 120 and the second blade bearing 120. The first portion 112 and the second portion 114 are facing each other across the main bearing flange 130.

Implementing the stiffening structures 140 as shown in this example increases the stiffness of the hub body 110 particularly in the first portion 112 and in the second portion 114. Thus, the stiffness around a circumference of the main bearing flange 130 can be equalized or levelled this way. Therefore, a main bearing (not shown) can have an increased service life compared to the case where no such stiffening structures 140 are used.

FIG. 2 shows a schematic view of a second example of a hub 100 for a wind turbine 200 (see FIG. 4). The hub 100 has a hub body 110 with one main bearing flange 130 and three blade bearing flanges 120, a first, a second and a third blade bearing flange 120. The blade bearing flanges 120 are arranged symmetrically around a rotational symmetry axis of the main bearing flange 130. The hub body 110 has three portions 112, 114, 116 having a relatively low stiffness. For example, the first portion 112 is arranged between the first blade bearing flange 120 and the second blade bearing flange 120, the second portion 114 is arranged between the second blade bearing flange 120 and the third blade bearing flange 120, and the third portion 116 is arranged between the third blade bearing flange 120 and the first blade bearing flange 120. Further, each of the first, second and third portion 112, 114, 116 is arranged adjacent to the main bearing flange 130.

In order to increase the stiffness of these portions 112, 114, 116 and to equalize the stiffness on a circumference around the main bearing flange 130, a stiffening structure 140 is arranged in the hub body 110. Here, the stiffening structure 140 consists of a Y-shaped plate made from steel. The shape may also be described as an equilateral triangle form with each side being curved towards a symmetry point of the triangle. By using this shape, three openings 145 are formed between the plate 140 and the hub body 110, through which the main bearing flange 130 or a main bearing mounted there can be accessed. The plate 140 further has a centrally arranged man hole 144, which reduces the weight of the plate 140 and allows further access to the inside of the hub body 110 for servicing.

In this example, the plate 140 is bolted to the hub body 110 using a number of bolts 146 (only one bolt 146 is designated with a reference numeral for better overview). The plate 140 may comprise a specific bolting section (not shown) and the hub body 110 may comprise a corresponding specific bolting section (not shown) for bolting the plate 140 to the hub body 110. The plate 140 connects and spans between the first, second and third portion 112, 114, 116 of the hub body 110. Thus, a stress or strain that acts or is applied to one of the first, second or third portion 112, 114, 116 will alike act on the plate 140 and be transferred by the plate 140 to the respective other two portions. Therefore, the hub body 110 cannot be deformed in the first portion 112, second portion 114 or third portion 116 individually, but only by involving the respective other portions.

FIG. 3 shows a schematic view of a third example of a hub 100 for a wind turbine 200 (see FIG. 4). The hub 100 comprises a hub body 110 which is similar to the hub body 110 of the hub 100 described with reference to FIG. 2. However, in this example, the stiffening structure 140 comprises three reinforcing elements 142. The reinforcing elements 142 each have the same shape. The reinforcing elements 142 are made from a composite material which has a very high stiffness-to-weight ratio, such that the reinforcing elements 142 are relatively light but can still transfer high tensile or compressive forces. Each one of the reinforcing elements 142 spans between and connects two of the first portion 112, second portion 114 or third portion 116. The reinforcing elements 142 are fixed to the hub body 110 at the respective positions by using bolts 146. Using these smaller reinforcing elements 142 makes it a lot easier to install them and mount them to the hub body 110.

Further, in order to increase the stiffness gain obtained by using the reinforcing elements 142, each two reinforcing elements 142 are joined with each other in a neighboring section. In this example, the reinforcing elements 142 are joined by means of joining plates 143, which are bolted by bolts 146 (only one bolt 146 is designated with a reference numeral) to the respective reinforcing element 142. This allows transfer of tensile or compressive forces between the reinforcing elements 142.

Together, the three reinforcing elements 142 form a shape that is similar to the Y-shaped plate 140 described with reference to FIG. 2.

The reinforcing elements 142 may have shapes that are different to what is shown in this example, such as rod-like, formed as a strut or spoke or the like.

FIG. 4 shows a schematic view of an example of a wind turbine 200. The wind turbine 200 comprises a tower 202 on which a rotor comprising a hub 100 and three blades 204 is arranged. For example, the hub 100 has the features of the hub 100 described with reference to FIG. 2 or FIG. 3. The wind turbine 200 is implemented as a direct drive wind turbine. For example, the rotor of the wind turbine 200 has a diameter of over 100 m. However, by using the hub 100 as described before, larger diameters can be realized easily because the hub body's 110 (see FIGS. 1-3) stiffness may be increased selectively in portions that have a relatively low stiffness by using a stiffening structure 140. The wind turbine 200 may be used both on-shore as well as off-shore.

Although the present embodiment has been described in accordance with the exemplary embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements

1. A hub for a wind turbine, comprising:
a hub body having a first blade bearing flange, a second blade bearing flange, and a main bearing flange; and
a stiffening structure stiffening a first portion of the hub body, wherein the first portion is arranged adjacent to the main bearing flange and between the first blade bearing flange and the second blade bearing flange.

2. The hub according to claim 1, wherein the stiffening structure comprises a rib formed integrally with the hub body.

3. The hub according to claim 1, wherein the hub body comprises a second portion, the second portion being arranged adjacent to the main bearing flange and between the first blade bearing flange and the second blade bearing flange, further wherein the first blade bearing flange or the second blade bearing flange is arranged between the first portion and the second portion, and the stiffening structure connects the first portion and the second portion.

4. The hub according to claim 3, wherein the stiffening structure spans from the first portion to the second portion such that an opening is formed between the stiffening structure and the hub body.

5. The hub according to claim 4, wherein the hub body comprises a third blade bearing flange and a third portion, the third portion being arranged adjacent to the main bearing flange and between the first blade bearing flange and the third blade bearing flange, further wherein at least one of the first blade bearing flange, the second blade bearing flange, and the third blade bearing flange is arranged between the first portion and the third portion and at least one other of the first blade bearing flange, the second blade bearing flange, and the third blade bearing flange is arranged between the second portion and the third portion, and the stiffening structure has a Y-shape connected to the hub body at the first portion, the second portion, and the third portion.

6. The hub according to claim 1, wherein the stiffening structure is arranged inside the hub body.

7. The hub according to claim 1, wherein the stiffening structure comprises at least two reinforcing elements joined to each other.

8. The hub according to claim 1, wherein the stiffening structure comprises at least one manhole.

9. The hub according to claim 1, wherein the main bearing flange has a diameter of at least two meters.

10. The hub according to claim 1, wherein the hub body is made from cast iron.

11. A wind turbine comprising a hub according to claim 1.

12. The wind turbine according to claim 11, wherein the wind turbine is a direct drive wind turbine.

13. A method for upgrading a hub of a wind turbine, wherein a stiffening structure is joined to a hub body of the hub, the hub body comprising a first blade bearing flange, a second blade bearing flange, and a main bearing flange, for stiffening a first portion of the hub body, the first portion being arranged adjacent to the main bearing flange and between the first blade bearing flange and the second blade bearing flange.
